(19) United States
(12) Patent Application Publication
(10) Pub. No.: US 2019/0055781 A1
(43) Pub. Date: Feb. 21, 2019

(54) Electric Folding Shade Device

(71) Applicant: Li-Ming Cheng, Kaohsiung City (TW)

(72) Inventor: Li-Ming Cheng, Kaohsiung City (TW)

(21) Appl. No.: 15/677,108

(22) Filed: Aug. 15, 2017

(51) Int. Cl. E06B 9/44

(52) U.S. Cl. CPC E06B 9/44; E06B 9/72

(57) ABSTRACT

An electric folding shade device includes a support in the form of a beam having a first end and a second end. A driving element and a transmission member are mounted to the first end of the support. The driving element drives the transmission member to rotate. A rotating shaft includes a first end coupled to the transmission member and a second end. An adjusting shaft is made of a non-metal material and includes a first end and a second end. The first end of the adjusting shaft is fitted with the second end of the rotating shaft. The adjusting shaft further includes a second end rotatably mounted to the second end of the support. A roller in the form of a hollow tube is fitted with the rotating shaft. A shade includes a first end fixed to the roller and a second end fixed to a weight.

### BACKGROUND

### 1. Technical Field

The present invention relates to an electric folding shade device and, more particularly, to an electric folding shade device including components that can be easily and conveniently cut by a user according to the desired size.

### 2. Description of the Related Art

FIG. 1 shows a conventional electric folding shade device 9 including a support 91, a shaft 92, a shade 93, and a weight 94. The support 91 includes a motor 911 and a positioning portion 912 respectively at two portions thereof. The motor 911 includes a transmission member 913. A first end of the shaft 92 has a transmission portion 921 coupled with the transmission member 913. A second end of the shaft 92 is coupled with the positioning portion 912. An end of the shade 93 is fixed to a roller 931 coupled to the shaft 92. The roller 931 and the shaft 92 can rotate jointly. The weight 94 is coupled to the other end of the shade 93.

The transmission member 913 drives the shaft 92 to rotate. Thus, the shaft 92 must be made of rigid metal to permit synchronous rotation of the shaft 92 and the transmission member 913 without the risk of loosening, thereby assuring subsequent folding or unfolding of the shade 93.

A user installing the electric folding shade device 9 can purchase in a shopping mall the desired components according to personal favorites, styles, colors, or the decoration atmosphere. The user can cut the components to the desired sizes meeting a size of a window in a house. However, most families do not have a machine for cutting the shaft 92 which is generally made of metal. Thus, the user must ask help from a factory or a shop, which is extremely inconvenient in use.

Thus, improvement to the conventional electric folding shade devices is necessary.

### SUMMARY

To solve the above problem, an objective of the present invention is to provide an electric folding shade device including components that can be easily and conveniently cut by a user according to the desired size.

When the terms “up”, “down”, “inner”, “outer” and similar terms are used herein, it should be understood that these terms have reference only to the structure shown in the drawings as it would appear to a person viewing the drawings and are utilized only to facilitate describing the invention, rather than restricting the invention.

An electric folding shade device according to the present invention includes a support in a form of a beam having a first end and a second end. A driving element and a transmission member are mounted to the first end of the support. The driving element drives the transmission member to rotate. A rotating shaft includes a first end coupled to the transmission member and a second end. An adjusting shaft is made of a non-metal material and includes a first end and a second end. The first end of the adjusting shaft is fitted with the second end of the rotating shaft. The adjusting shaft further includes a second end rotatably mounted to the second end of the support. A roller in a form of a hollow tube is fitted with the rotating shaft. A shade includes a first end adapted to be fixed to the roller and a second end adapted to be fixed to a weight.

Thus, since the adjusting shaft of the electric folding shade device according to the present invention is made of a non-metal material, the user can use a cutting tool, that is simple or that can be obtained easily, to cut the adjusting shaft according to the desired length. After cutting. The adjusting shaft is coupled to the rotating shaft. Thus, the size of the electric folding shade device can be easily adjusted, providing convenience in installation and use.

In an example, two seats are respectively coupled to the first end and the second end of the support to provide convenient assembly.

In an example, the support further includes a groove extending from the first end through the second end of the support, and each of the two seats includes a connecting portion detachably coupled in the groove of the support, providing convenient assembly.

In an example, one of the two seats fixed to the second end of the support includes a positioning portion, and the second end of the adjusting shaft is rotatably mounted to the positioning portion, providing convenient assembly.

In an example, the rotating shaft includes an engaging portion engaged with the transmission member to assure rotational smoothness.

In an example, adjusting shaft includes a second fixing member, and the rotating shaft and the adjusting shaft are fixed together by the second fixing member. This enhances the coupling effect between the rotating shaft and the adjusting shaft.

In an example, the rotating shaft and the adjusting shaft are fixed together by a connecting member to provide convenient connection.

In an example, the connecting member includes a first end fitted with the second end of the shaft and a second end fitted with the first end of the adjusting shaft, providing convenient connection.

In an example, the adjusting shaft includes two second fixing members. The rotating shaft and connecting member are fixed by one of the two second fixing members. The adjusting shaft and the connecting member are fixed together by the other of the two second fixing members.

In an example, the adjusting shaft is made of a paper roll or plastic to permit easy cutting.

The present invention will become clearer in light of the following detailed description of illustrative embodiments of this invention described in connection with the drawings.

### BRIEF DESCRIPTION OF THE DRAWINGS

FIG. 1 is an exploded, perspective view of a conventional electric folding shade device.

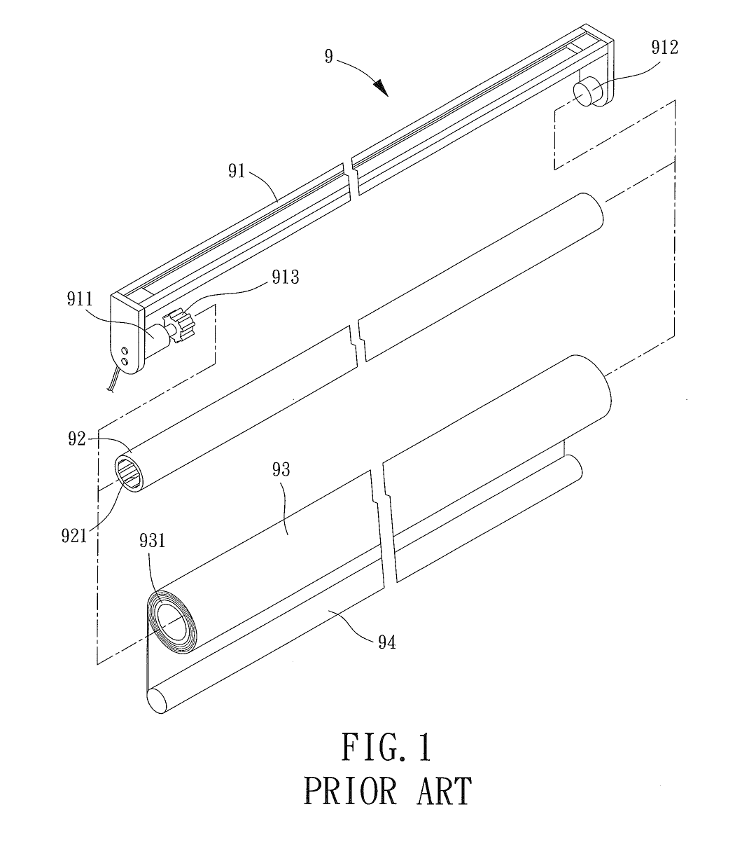

FIG. 2 is an exploded, perspective view of an electric folding shade device of a first embodiment according to the present invention.

FIG. 3 is a cross sectional view of the electric folding shade device of FIG. 2.

FIG. 4 is a cross sectional view of a modified example of the electric folding shade device of FIG. 3.

FIG. 5 is an exploded, perspective view of an electric folding shade device of a second embodiment according to the present invention.

FIG. 6 is a cross sectional view of the electric folding shade device of FIG. 5.

FIG. 7 is a cross sectional view of a modified example of the electric folding shade device of FIG. 6.

### DETAILED DESCRIPTION

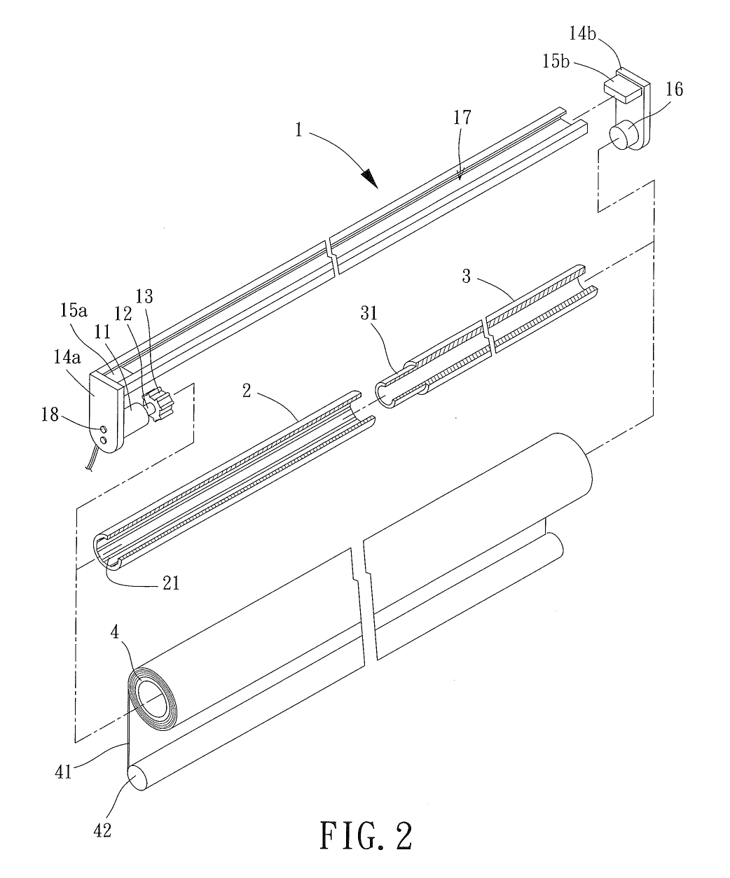

With reference to FIG. 2, a first embodiment of an electric folding shade device according to the present invention includes a support 1, a rotating shaft 2, an adjusting shaft 3, and a roller 4. A first end of the rotating shaft 2 is coupled to a first end of the support 1. A second end of the rotating shaft 2 is coupled to a first end of the adjusting shaft 3. A second end of the adjusting shaft 3 is coupled to a second end of the support 1. The roller 4 is fitted with the rotating shaft 2, such that the roller 4 and the rotating shaft 2 are jointly rotatable.

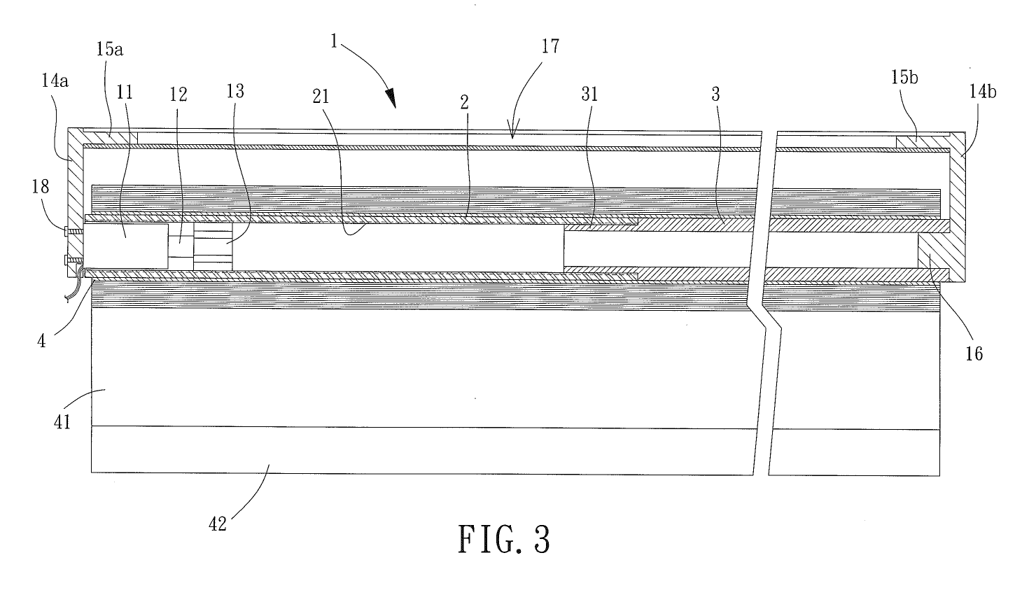

With reference to FIGS. 2 and 3, the support 1 is made of a non-metal material and is in the form of a beam including the first end and the second end. Two seats 14a, 14b are respectively coupled to the first end and the second end of the support 1. A driving element 11 is mounted to the first end of the support 1. The driving element 11 is fixed to the seat 14a by at least one fixing member 18. The driving element 11 includes a rotating shaft 2 coupled to a transmission member 13. The transmission member 13 can be in the form of a gear and can be driven by the driving element 11 to rotate. The second end of the support 1 includes a positioning portion 16. In this embodiment, the positioning portion 16 is formed on the seat 14b fixed to the second end of the support 1. Each of the two seats 14a and 14b includes a connecting portion 15a, 15b for detachable assembly with the first and second ends of the support 1. After the connecting portions 15a and 15b have been detached from the support 1, the support 1 can be cut to the desired length, and the connecting portions 15a and 15b can be reattached to in a groove 17 in the support 1. Thus, the length of the support 1 can be adjusted by a user according to need.

Still referring to FIGS. 2 and 3, the first end of the rotating shaft 2 is coupled to the transmission member 13. The second end of the rotating shaft 2 is coupled to the first end of the adjusting shaft 3. The rotating shaft 2 can be coupled to the transmission member 13 by an engaging portion 21. The engaging portion 21 includes a plurality of inner teeth for meshing with the transmission member 13. Thus, the rotating shaft 2 can be driven by the transmission member 13 to proceed with synchronous rotation. The rotating shaft 2 is made of metal.

The second end of the adjusting shaft 3 is rotatably mounted to the positioning portion 16 at the second end of the support 1. The first end of the adjusting shaft 3 includes a coupling portion 31 fitted with the second end of the rotating shaft 2. The coupling portion 31 can be fitted with an inner periphery or an outer periphery of the rotating shaft 2. In this embodiment, the coupling portion 31 is fitted in the adjusting shaft 3. Furthermore, an outer diameter of the adjusting shaft 3 is the same as an outer diameter of the rotating shaft 2. It is noted that the adjusting shaft 3 is made of a non-metal material, such as a paper roll or plastic. Thus, the user can easily and conveniently cut the adjusting shaft 3 to the desired length.

The roller 4 is coupled with the rotating shaft 2 and can be in the form of a hollow tube fitted with the rotating shaft 2, such that the roller 4 and the rotating shaft 2 rotate synchronously. A shade 41 includes a first end adapted to be fixed to the roller 4 and a second end adapted to be fixed to a weight 42. The weight 42 can be in the form of a cylindrical member to provide an aesthetic appearance. Thus, when the rotating shaft 2 rotates, the shade 41 can be coiled upward or pulled downward to an extended state. Specifically, the roller 4 is also made of a non-metal material to permit cutting by the user to the desired length.

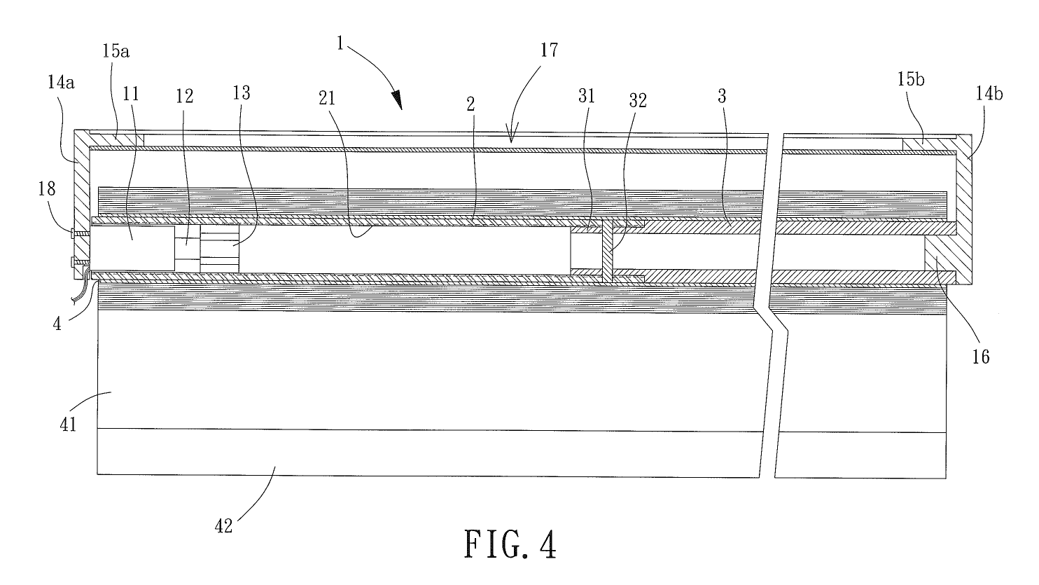

With reference to FIG. 4, after the coupling portion 31 of the adjusting shaft 3 has been fitted with the rotating shaft 2, the rotating shaft 2 and the adjusting shaft 3 can be fixed together by a second fixing member 32 to enhance the coupling effect between the rotating shaft 2 and the adjusting shaft 3, permitting synchronous rotation of the rotating shaft 2 and the adjusting shaft 3. Furthermore, after the roller 4 has been fitted with the adjusting shaft 3, the adjusting shaft 3 can drive the roller 4 to rotate synchronously.

With reference to FIGS. 2 and 4, in use, the user can use a control member (not shown) to activate the driving element 11, which, in turn, drives the transmission member 13 to rotate synchronously. Since the rotating shaft 2 engages with the transmission member 13 (such as by meshing), the rotating shaft 2 drives the adjusting shaft 3 to rotate synchronously, thereby coiling the shade 41 upward or pulling the shade 41 downward to an extended state.

By providing the above structure, in installation of the first embodiment of the electric folding shade device according to the present invention, since the adjusting shaft 3 is made of a non-metal material and is, thus, easy to cut, the user can use a cutting tool, that is simple or that can be easily obtained, to cut the adjusting shaft 3 according to the desired length. Then, the rotating shaft 2 is fitted with the coupling portion 31 of the adjusting shaft 3. Thus, the size of the electric folding shade device can be easily adjusted.

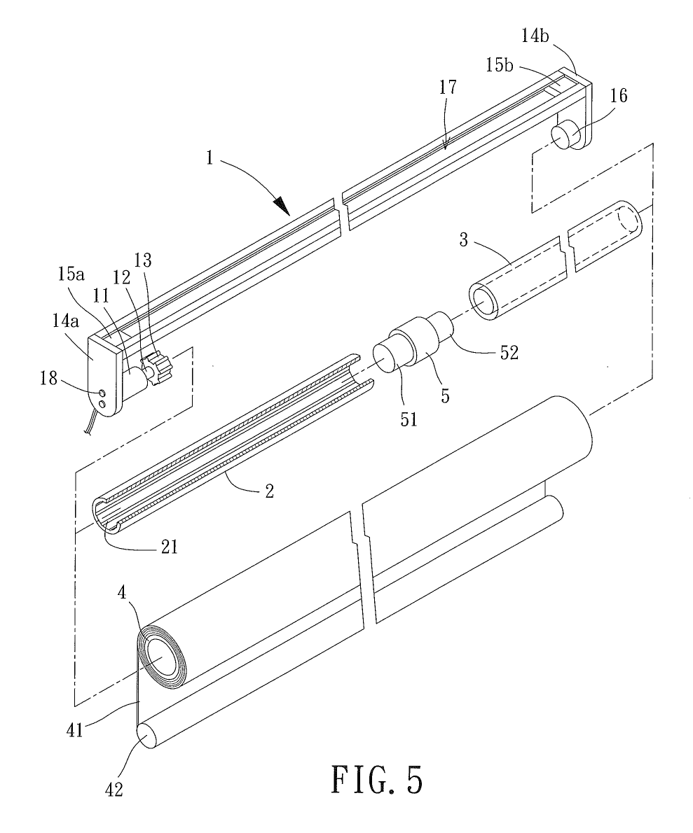

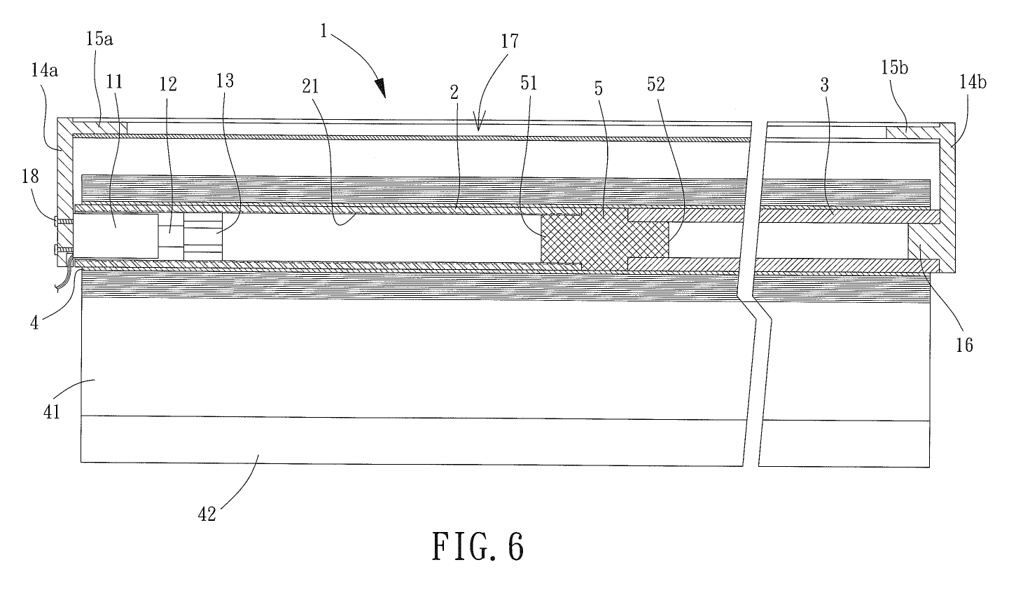

FIGS. 5 and 6 show an electric folding shade device of a second embodiment according to the present invention. In this embodiment, the second end of the rotating shaft 2 and the first end of the adjusting shaft 3 are fixed together by a connecting member 5. The connecting member 5 includes a first end 51 fitted with the second end of the rotating shaft 2. The first end 51 can be fitted with an inner periphery or an outer periphery of the rotating shaft 2. The connecting member 5 further includes a second end 52 fitted with the first end of the adjusting shaft 3. The second end 52 can be fitted with an inner periphery or an outer periphery of the adjusting shaft 3. In this embodiment, after the connecting member 5 has been fitted with the rotating shaft 2 and the adjusting shaft 3, the outer periphery of the connecting member 5 is flush with the outer peripheries of the rotating shaft 2 and the adjusting shaft 3.

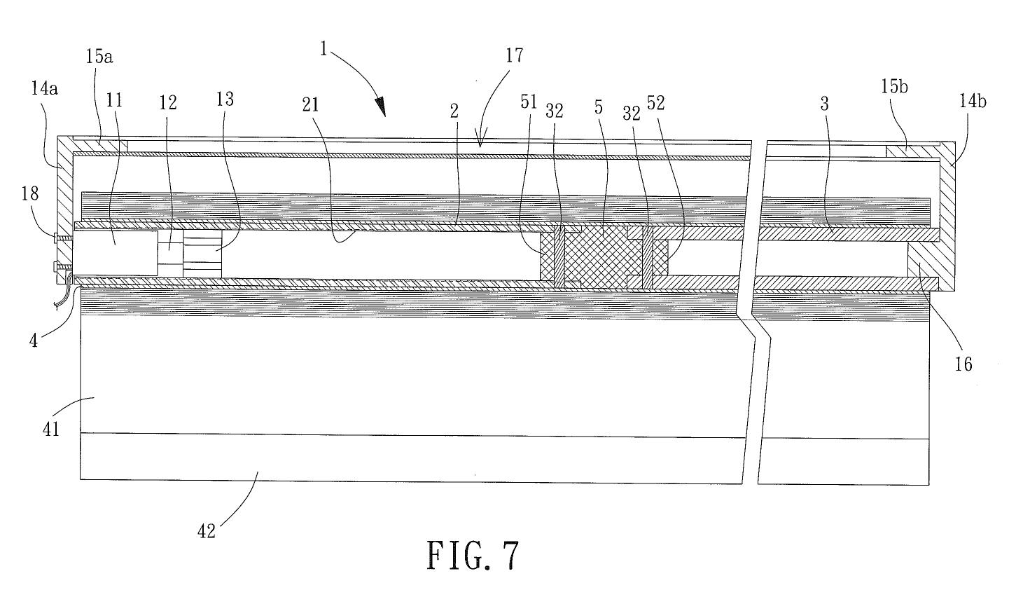

With reference to FIG. 7, after the first end 51 and the second end 52 of the connecting member 5 are respectively fitted with the second end of the rotating shaft 2 and the first end of the adjusting shaft 3, the adjusting shaft 3 and the connecting member 5 can be fixed by a second fixing member 32, and the rotating shaft 2 and the connecting member 5 can be fixed by another second fixing member 32. Thus, the rotating shaft 2 and the adjusting shaft 3 can be securely fixed together to permit synchronous rotation of the adjusting shaft 3 and the rotating shaft 2. Furthermore, after the roller 4 has been fitted with the adjusting shaft 3, the adjusting shaft 3 can drive the roller 4 to rotate synchronously.

By providing the above structure, in installation of the second embodiment of the electric folding shade device according to the present invention, since the adjusting shaft 3 is made of a non-metal material and is, thus, easy to cut, the user can use a tool, that is simple or that can be easily obtained, to cut the adjusting shaft 3 according to the desired length. Then, the rotating shaft 2 is fitted with the first end 51 of the connecting member 5, and the second end 52 of the connecting member 5 is fitted with the coupling portion 31 of the adjusting shaft 3. Thus, the size of the electric folding shade device can be easily adjusted.

In view of the foregoing, a user of the electric folding shade device according to the present invention can use a cutting tool, that is simple or that can be obtained easily, to cut the adjusting shaft 3 according to the desired length. Thus, the size of the electric folding shade device can be easily adjusted, providing convenience in installation and use.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. An electric folding shade device comprising:
a support in a form of a beam including a first end and a second end, wherein a driving element and a transmission member are mounted to the first end of the support, and wherein the driving element drives the transmission member to rotate;
a rotating shaft including a first end coupled to the transmission member and a second end;
an adjusting shaft made of a non-metal material and including a first end and a second end, wherein the first end of the adjusting shaft is fitted with the second end of the rotating shaft, wherein the second end of the adjusting shaft is rotatably mounted to the second end of the support; and
a roller in a form of a hollow tube fitted with the rotating shaft, wherein a shade includes a first end adapted to be fixed to the roller and a second end adapted to be fixed to a weight.

2. The electric folding shade device as claimed in claim 1, further comprising two seats respectively coupled to the first end and the second end of the support.

3. The electric folding shade device as claimed in claim 2, wherein the support further includes a groove extending from the first end through the second end of the support, and wherein each of the two seats includes a connecting portion detachably coupled in the groove of the support.

4. The electric folding shade device as claimed in claim 2, wherein one of the two seats fixed to the second end of the support includes a positioning portion, and wherein the second end of the adjusting shaft is rotatably mounted to the positioning portion.

5. The electric folding shade device as claimed in claim 1, wherein the rotating shaft includes an engaging portion engaged with the transmission member.

6. The electric folding shade device as claimed in claim 1, wherein adjusting shaft includes a second fixing member, and wherein the rotating shaft and the adjusting shaft are fixed together by the second fixing member.

7. The electric folding shade device as claimed in claim 1, further comprising a connecting member, wherein the rotating shaft and the adjusting shaft are fixed together by the connecting member.

8. The electric folding shade device as claimed in claim 7, wherein the connecting member includes a first end and a second end, wherein the first end of the connecting member is fitted with the second end of the rotating shaft, and wherein the second end of the connecting member is fitted with the first end of the adjusting shaft.

9. The electric folding shade device as claimed in claim 8, wherein the adjusting shaft includes two second fixing members, wherein the rotating shaft and connecting member are fixed by one of the two second fixing members, and wherein the adjusting shaft and the connecting member are fixed together by another of the two second fixing members.

10. The electric folding shade device as claimed in claim 1, wherein the adjusting shaft is made of a paper roll or plastic.
